(19) United States
(12) Patent Application Publication
(10) Pub. No.: US 2013/0248395 A1
(43) Pub. Date: Sep. 26, 2013

(54) MEDICAL WASTE SYSTEM

(71) Applicant: Bryan Guthrie, Cornelius, NC (US)

(72) Inventor: Bryan Guthrie, Cornelius, NC (US)

(73) Assignee: GUARDIANOR, Cornelius, NC (US)

(21) Appl. No.: 13/848,933

(22) Filed: Mar. 22, 2013

Related U.S. Application Data
(60) Provisional application No. 61/614,485, filed on Mar. 22, 2012.

(51) Int. Cl. A61J 1/00

(52) U.S. Cl. CPC A61J 1/00
USPC 206/365

(57) ABSTRACT

A medical disposal system is disclosed that includes a generally upright body portion formed of a material that is amenable to disinfectant in the hospital environment and that has surfaces shaped for easy cleaning in the hospital environment. The system has at least two separate waste disposal portions. A first portion is for waste other than sharps and has an opening large enough to receive waste that is typically other than sharps in the hospital environment including disposable clothing The opening to the first waste portion has a metal detector and an indicator system for providing a notification when a metal item is unintentionally placed in the opening. A second waste portion is for waste sharps and includes a relatively rigid sharps container and a safety lid that precludes sharps from leaving the container through the sharps opening.

### RELATED APPLICATIONS

This application claims priority from Application Ser. No. 61/614,485 filed Mar. 22, 2012

BACKGROUND

The invention relates to convenient waste disposal in medical settings, including sharps disposal and point of loss metal detecting trash cans for medical use.

The medical environment tends to generate three main forms of trash: sharps, biohazard materials, and ordinary trash. Hospital staff tends to waste money by negligently discarding equipment after surgery, typically by unintentionally depositing metal items (e.g., surgical tools) into the trash along with disposable garments (surgical “scrubs”) and other potentially hazardous biological waste. A conventional attempt at solving the problem incorporates a metal detector with a trash can.

Additionally, in most medical environments (e.g., doctors' offices, hospital rooms, and surgical suites) some provision must be made for the safe disposal of “sharps.” Federal regulations (e.g., 49 CFR 173.134) define a “sharp” as any object that may be contaminated with a pathogen and that is capable of cutting or penetrating skin or a packaging material (and thus leading to injury or disease transmission or both). Examples of “sharps” include needles, scalpels, broken glass, and culture dishes, etc. Both best practices and Federal regulations (e.g., 49 CFR 173.197) also require that sharps be placed in containers that are rigid, leak resistant, impervious to moisture, strong enough to prevent tearing or bursting during normal conditions of transport, and puncture resistant.

In statistical terms, US hospitals produce a vast amount of waste estimated at more than 6600 tons per day or 4,000,000,000 pounds annually. An operating room tends to generate two main forms of trash; single use sterilized equipment and regular garbage which is sometimes needlessly bagged as hazardous waste. The well-understood red bags are intended to be used for medical waste that requires more cautious-and thus more expensive-disposal procedures. Some research indicates, however, that up to 90% of items disposed in special red bags are simply regular trash that could be stored in a clear bag and disposed of more conveniently. Thus, a more efficient segregation and disposal of trash could provide significant cost savings in the healthcare industry.

Currently available medical disposal and detector systems have a number of drawbacks or lack helpful functions. In some, the openings tend to be unfinished and expose the contents of a biohazard bag. The structural materials can be weak and not as sturdy as conventional industrial disposals. Because a sterile environment is a fundamental hospital goal, certain types of plastics—especially inexpensive ones—do not necessarily reassure the user as to their cleanliness. Some plastics interact slightly with hospital cleaning materials and develop an undesired sticky texture.

In some cases the structures are angular with protruding surfaces and corners, which in turn can catch on medical clothing and draping.

Many structures are singular in their function, so that separate items are needed for the several types of expected waste, which in turn tends to crowd the medical space in an undesired, or in some cases an unsafe or unsanitary, manner.

Some of the controls on current metal detecting devices for the medical environment fail to offer a clear visible hierarchy as to their function; i.e., all of the control buttons appear to have the same importance. Similarly, many control panels fail to give feedback to the user. Lids can be flimsy, and the use of tape to hold a disposal bag in place appears primitive in an otherwise high-tech device and environment. In some existing devices, the hazard bag is totally exposed creating a risk of puncture. In some cases, the hospital requires a solid walled container.

In a surgical suite, a disposal system also must work consistently with the suite environment. Surgical suites can be extremely crowded, especially when between three and six member surgical teams are working with a patient. Because of this, a disposal system that cannot move freely or fit into unobtrusive areas is disadvantageous. Indeed, a cluttered operating room can be disadvantageous or even disastrous from a medical standpoint.

Furthermore, because an operating room typically is a stressful environment (for good and proper reasons), certain types of metal detection notifications (e.g., a buzzer or bell) can be distracting.

In less crowded operating rooms, space saving capabilities may be less important, but other factors such as sanitation and range of movement can become more important. In either environment, disposal containers that have separate compartments for sharps, biohazards, and trash take up significant amounts of space.

Some currently available waste disposal bins include rolling containers similar to those used for curbside garbage collection, open frames for plastic bags, small buckets with biohazard liners, and other similar, generally less advantageous structures.

Other typical problems include difficulty in changing bags (for example some require a screwdriver), storing of the electrical equipment used to detect the metal, and inconveniently located controls. Other devices suffer from false positives (i.e., they indicate that metal has been discarded when in reality it has not) and from the seemingly simple problem that they present one more trash container—or several trash containers—for the user to identify before use.

Additionally, appropriate devices must also meet medical regulations for safely storing biohazard materials. For example, The Bloodborne Pathogens Standard of the US Occupational Safety and Health Administration (OSHA) uses the term, “regulated waste,” to refer to waste items such as liquid or semi-liquid blood or other potentially infectious materials (OPIM); items contaminated with blood or OPIM and which would release these substances in a liquid or semi-liquid state if compressed; items that are caked with dried blood or OPIM and are capable of releasing these materials during handling; contaminated sharps; and pathological and microbiological wastes containing blood or OPIM. Because of these standards, in most circumstances disposal devices should accept the standard “red bag” used in the hospital environment. The device must be waterproof so that it can be cleaned easily and completely and those portions of devices that are in contact with hazardous materials must be formed of a material that is impermeable rather than porous.

Because of their structure, changing the bag in conventional devices can be inefficient and slow. Also, systems that require significant user strength are inappropriate in the hospital environment because much work is done by smaller persons. For example, on a percentile basis, in order to capture 99% of potential users, the device should be easily handled by a 115 pound middle-age female.

Existing devices sometimes preclude access to the full bag or to new bags, are sometimes improperly balanced, may not withstand the weight strain of an overly full or leaning load (which can approach 75 pounds), do not offer any method of separating large and small biohazard materials, or provide a separate area for disposing of non⁻ biohazard materials.

Conventionally available devices include those such as illustrated and described in U.S. Pat. No. 6,833,789. Other related devices are available from Xeku. Wand detectors are also used in some circumstances but are not necessarily convenient for the operating room environment.

### SUMMARY

A medical disposal system is disclosed that includes a generally upright body portion formed of a material that is amenable to disinfectant in the hospital environment and that has surfaces shaped for easy cleaning in the hospital environment. The system has at least two separate waste disposal portions. A first portion is for waste other than sharps and has an opening large enough to receive waste that is typically other than sharps in the hospital environment including disposable clothing The opening to the first waste portion has a metal detector and an indicator system for providing a notification when a metal item is unintentionally placed in the opening. A second waste portion is for waste sharps and includes a relatively rigid sharps container and a safety lid that precludes sharps from leaving the container through the sharps opening.

### BRIEF DESCRIPTION OF THE DRAWINGS

FIG. 1 is a perspective view of a medical waste system according to the invention.

FIG. 2 is an exploded perspective view of the invention.

FIG. 3 is a perspective view of a second embodiment of the invention.

FIG. 4 is a side elevation view.

FIG. 5 is a top plan view of the invention.

FIG. 6 is a horizontal cross-section taken along lines 6-6 of FIG. 5.

FIG. 7 is a vertical cross-section taken along lines 7-7 of FIG. 4.

FIG. 8 is a enlarged perspective view of the tray portion of the invention.

### DETAILED DESCRIPTION

The invention is a medical disposal system that provides ease-of-use, particularly in changing bags, charging the metal detecting electronics, moving the device from place to place, lifting and replacing the lid, and otherwise handling medical waste in bags in the device.

It will be understood that the term “waste” is used as an example rather than a limitation. In the medical context, some items that are disposed of in an immediate sense are also (in a longer sense) cleaned or refurbished and reused, or alternatively recycled. The invention is applicable in conjunction with such uses.

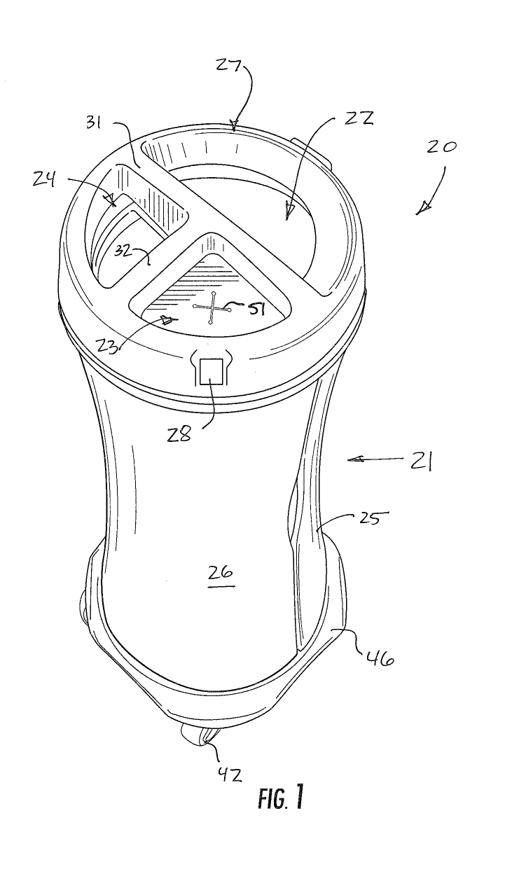

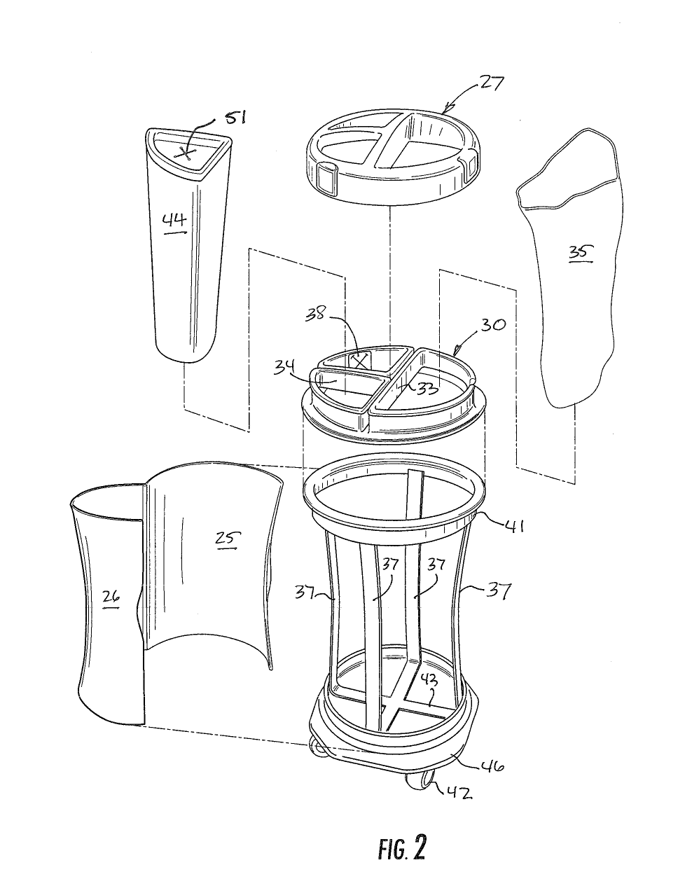

FIGS. 1 and 2 are perspective views (FIG. 2 is exploded) of a waste system broadly designated at 20 according to the present invention. The waste system 20 includes an upright body portion broadly designated at 21 which in the illustrated embodiment has a generally cylindrical cross section and also includes the doors 25 and 26.

The waste system 20 includes at least two separate disposal portions and FIGS. 1 and 2 illustrate three such portions. A first portion 22 is for waste material other than sharps, and has an opening large enough to receive waste that is typically other than sharps in the hospital environment; e.g. disposable clothing. The opening to the first waste portion 22 has a metal detector (not illustrated in the perspective views) that is incorporated in the electronics cover broadly designated at 27. The metal detector includes an indicator system for providing notification when a metal item is unintentionally placed in the opening. In FIG. 1, this is illustrated as an optical display 28.

The waste system 20 also includes a second portion 23 that includes a relatively rigid sharps container 44 (e.g. FIG. 2) and its lid opening 51 that precludes sharps from leaving the container through the sharps opening. If desired, either the sharps opening 51 or another fixture can be included so that a user can physically dull a sharp as part of the formal disposal protocol.

As illustrated in FIGS. 1 and 2, the doors 25 and 26 permit access to bag waste or the sharps container laterally to the upright body 21 rather than through the top of the system. The doors thus eliminate the necessity of lifting either a bag or a sharps container out of the waste disposal system (although the option to do so remains). The design is particularly consistent with the safety of the user and makes changing a trash container (i.e., a red bag) much easier for the user and much easier to do carefully.

The exploded perspective view of FIG. 2 also shows the electronics cover 27 and the tray 30 separated from the upright body portion 21. With the door 25 illustrated as being open, FIG. 2 also illustrates a waste bag 35 in the system 20.

FIGS. 1 and 2 also illustrate that the electronics cover 27 includes one or more cover dividers, two of which are illustrated at 31 and 32. It will be understood, of course, that the invention is not limited to three compartments and two cover dividers, but that a single compartment or (for example) a fourth compartment can be defined by adding or subtracting the amount and placement of such cover dividers.

FIG. 2 also illustrates the tray 30 which helps establish the first and second (or additional) waste portions. The tray 30 corresponds generally in shape to the upright body portion and thus is circular in the generally cylindrical embodiments illustrated in the Figures. If the body portion has a different shape, of course, the tray likewise has a different corresponding shape. In a manner analogous to the electronics cover, the tray 30 includes one or more dividers, two of which are illustrated at 33 and 34 in the Figures. FIG. 2 also illustrates that one or more of the tray dividers can include a bag securing insert of the type available under the “Presssix” trademark e.g. US Patent Application Publication No. 20070289972. Other bag lock possibilities can include locking rings, locking brackets, threaded fixtures, or other related items.

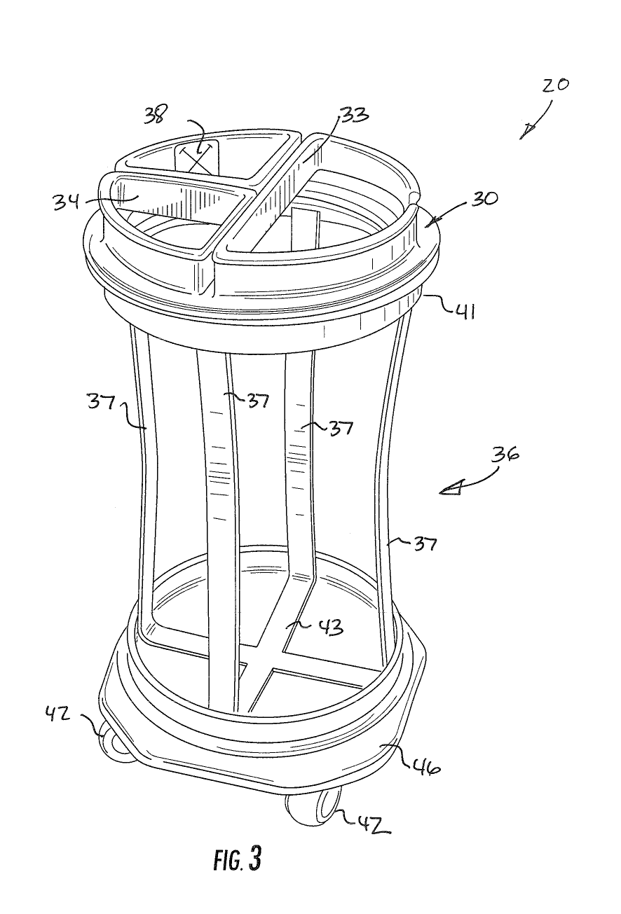

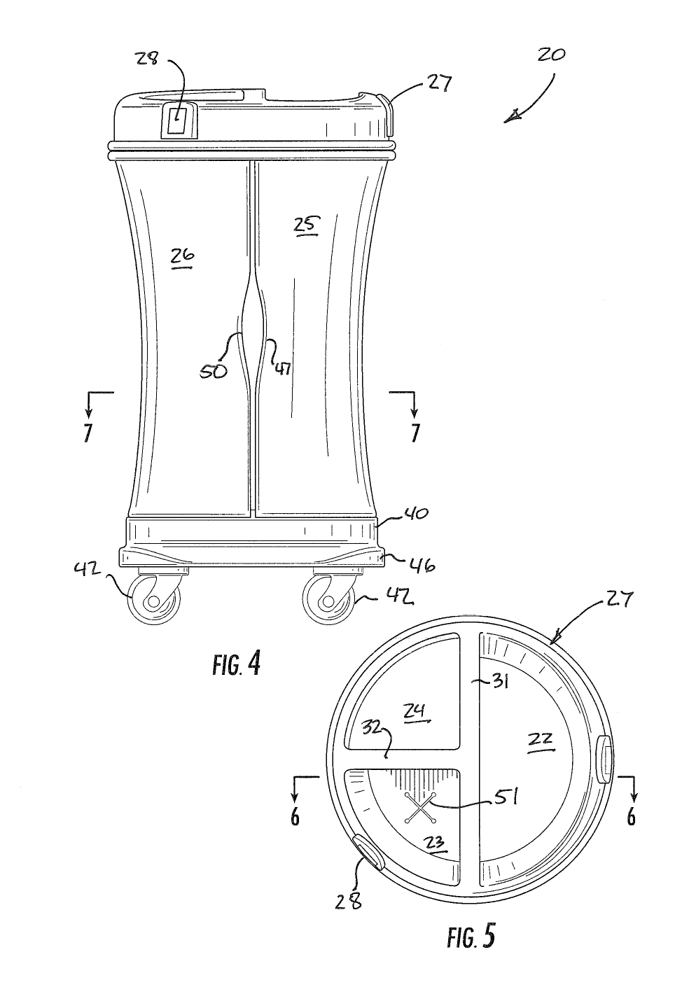

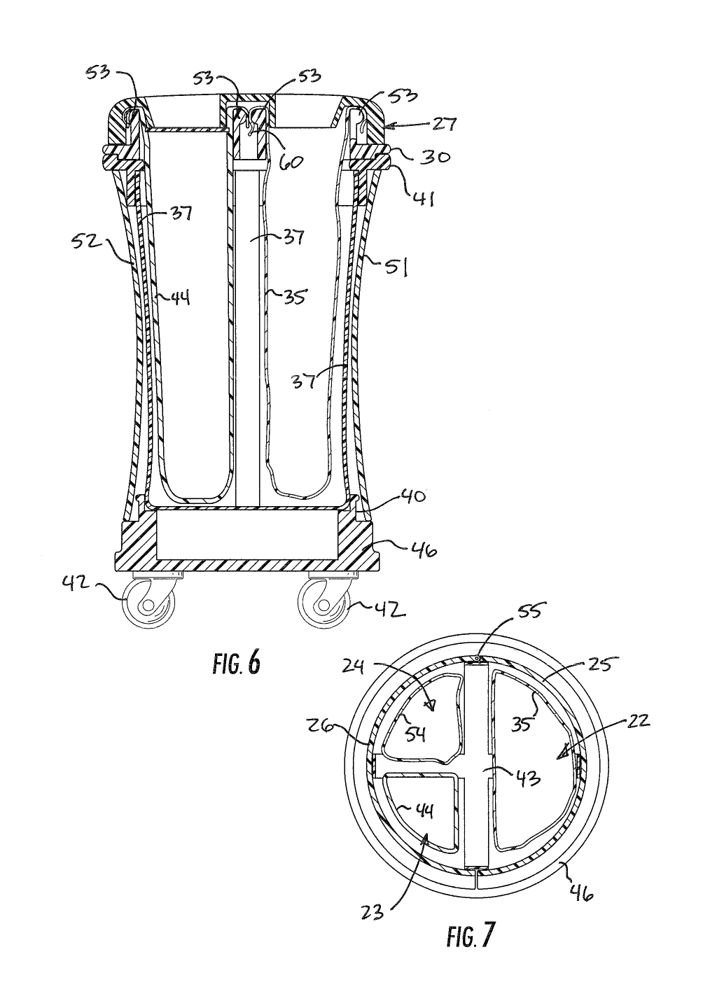

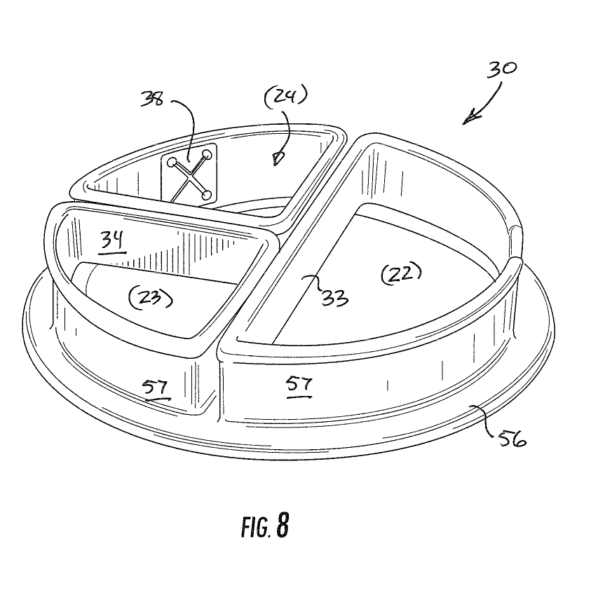

FIG. 3 is another perspective view of the waste system again broadly designated at 20 but in an embodiment that does not include the doors. This embodiment may be convenient for circumstances where the doors are unnecessary, and provides an additional option for manufacture and use.

In the embodiment illustrated in FIG. 3, the upright body portion is broadly designated at 36 and is formed of a plurality of armature uprights 37, four of which are illustrated. The exploded view of FIG. 3 also illustrates that the armature uprights bridge and support a top hoop 41 and a base hoop 40. In the illustrated embodiment, the uprights 37 are joined to a cross brace 43 that is generally coplanar or in a parallel plane with the base hoop 40.

FIG. 3 also helps illustrate that in many embodiments, the cylindrical body portion 21 or 36 can be supported on a plurality of casters 42, with four casters being a typical choice. The casters 42 make it easy to move the waste system 20 from place to place without the necessity of lifting it.

The invention has a stable base, a recorder for keeping track of the number of alerts, or tools used, or both; both audible and visual feedback, and efficiently designed openings and clearance. For example, one embodiment has a 13 inch diameter overall opening making it extremely convenient for the operating room environment.

The invention includes a solid wall container and meets all hospital regulations for disposal containers. The invention is easily recognizable as containing potentially hazardous material, is designed to operate in the sterile environment (including some proactive sterility features) and in its design aspects offers a high-end hospital anesthetic.

The invention is designed to exceed current requirements for such disposal containers and has advantageous detection and removal capabilities, including magnetic attraction for metal parts. The control screens can include either or both of liquid crystal display (LCD) or light emitting diode (LED) touch screens. The device is preferably formed of ecologically friendly plastics; i.e. those that are more rapidly biodegradable than most conventional plastics. Examples include (but are not limited to) polyhydroxyalkanoate (“PHA”), polylactic acid (“PLA”) and polycaprolactone (“PCL”).

The nature and operation of metal detectors are well established and well understood. Basically, a power source provides current to a set of metal wires, often in the shape of a circle or near-circle. This is generally referred to as the “coil” or “loop.” In the presence of metals near the coil other than the coil, the conductivity of the coil changes. Depending upon the sensitivity of the associated electronics, the detector will perceive and signal the changed conductivity, with typical signals including audio, visual, vibration, or some combination of these or other signals. In many circumstances the electronics can be tuned to provide a desired level of sensitivity. Typically, and particularly in portable devices such as the invention, the detector power is supplied by an appropriate battery. In some circumstances, the detector can be “detuned” to reduce the sensitivity, or to establish a null setting, or to discriminate between and among certain types of metals (for example eliminating iron and related alloys while detecting nickel and gold).

In other embodiments, the invention can use ultraviolet light disinfection and includes waterproof electronics consistent with the necessity of repetitive cleaning with sanitizing fluids. If desired, the device can biometrically record users and is particularly helpful to nurses and staff who will tend to be the most frequent persons to handle trash, metal items, and biological waste.

The design is consistent with the operating room environment and avoids interfering with the activities in the operating room. As is known to those familiar with the hospital environment, operating rooms are “taken down” for cleaning between uses, and the device must be consistent with such activities.

In some embodiments, the invention is compartmentalized and includes metal detection; sharps contentment; antibacterial (e.g. MICROBAN) plastics; compaction capabilities; fluid collection capabilities; radio frequency identification (RFID) capacity (which helps locate a specific disposal unit); an ultraviolet (UV) light ban at entry to kill germs and bacteria; and a lid which can be configured to open up different sections or different amounts of the opening.

Aluminum offers an advantage as a material because it is durable, relatively easy to disinfect, and sustainable. Some statistics indicate that two thirds of all of the aluminum ever produced remains in use today in some fashion. In the food packaging industry, aluminum from used packaging can be recycled, formed into a new package and back on a retail shelf in as little as 60 days.

Glass (or a ceramic) is also relatively simple to use and recycle, and in many cases can be made strong enough to minimize or eliminate the risk of breakage.

In some embodiments, the controls for the invention will incorporate touch screens, for example those that incorporate liquid crystal display (LCD) technology. Touch screens offer significant ease-of-use, but require programming and calibration. In some cases, the plastics used to cover LCD displays in other environments (e.g., office use) are incompatible with (i.e., react with) a number of the cleaners used for sanitary purposes in a hospital. Accordingly, in the invention touch screens can incorporate more rugged plastics or potentially glass.

The invention can also incorporate UV sanitation. As is well understood in the art, appropriate data demonstrates that ultraviolet frequencies are as effective—and in some cases more effective—than liquid disinfectants such as sodium hypochlorite (e.g., Clorox) or benzalkonium chloride (e.g., Lysol). In particular, ultraviolet radiation in the 200-280 nm range (“short wave UV” or “UV-C”) is effective for germicidal purposes because at (for example) a wavelength of 254 nm, UV light breaks molecular bonds within the DNA of microorganisms which in turn destroys the organism, renders them harmless, or simply prohibits growth and reproduction. Stated simply, microorganisms cannot survive prolonged exposure to ultraviolet light.

Although the illustrated embodiments have circular cross sections, these are exemplary rather than limiting. Thus, the invention can include a corner-based design formed of a solid polygon of the relevant material (including curved surfaces). In this regard, it will be understood that the invention can take the form of additional cross-sections, (taken either horizontally or vertically or both) that match certain general shapes (corners, rectangles) or are custom shapes (to fit within customized or less regular spaces).

In the corner-based design, two of the horizontal side walls are oriented at 90° to one another and the front wall of the device is formed of a curve or arc between the 90° walls. This allows the container to be positioned in a convenient corner, while the generally linear horizontal vertical walls also allow two or more units to be nested or mated to one another to create larger stations.

In this and other embodiments, the metal detector includes a counting device and an appropriate display. Both the counting system and the display can be digitally driven by an appropriate processor

In the drawings and specification there has been set forth a preferred embodiment of the invention, and although specific terms have been employed, they are used in a generic and descriptive sense only and not for purposes of limitation, the scope of the invention being defined in the claims.

1. A medical waste disposal system comprising:
a generally upright body portion formed of a material that is amenable to disinfectant in the hospital environment and having surfaces shaped for easy cleaning in the hospital environment;
at least two separate disposal portions;
a first portion for waste other than sharps, said first waste portion having an opening large enough to receive waste that is typically other than sharps in the hospital environment;
said opening to said first waste portion having a metal detector and an indicator system for providing a notification when a metal item is unintentionally placed in said opening;
a second waste portion for waste sharps; said second portion including a relatively rigid sharps container and a safety lid that precludes sharps from leaving the container through the sharps opening; and

2. A medical waste disposal system according to claim 1 wherein said upright body portion includes at least one door oriented inside portions of the body for permitting access to bag waste or the sharps container laterally to the upright body rather than through the top of the upright body to thereby eliminate the necessity of lifting either a bag or a sharps container out of the waste disposal system.

3. A medical waste disposal system according to claim 1 wherein said opening to said first portion is large enough to receive items of clothing.

4. A medical waste disposal system according to claim 1 wherein said body portion is substantially cylindrical.

5. A medical waste disposal system according to claim 1 further comprising a third waste portion for non-biological waste other than sharps.

6. A medical waste disposal system according to claim 2 further comprising at least one door positioned to provide access to said third portion.

7. A medical waste disposal system according to claim 1 further comprising casters at the base of said upright body portion for allowing the waste disposal system to be moved easily within the hospital environment.

8. A medical waste disposal system according to claim 1 further comprising a light indicator for the metal detector.

9. A medical waste disposal system according to claim 1 further comprising a sound indicator for the metal detector.

10. A medical waste disposal system according to claim 1 wherein said upright body portion comprises:
a plurality of armature uprights;
a base to support said armature uprights; and
a top hoop supported by said armature uprights.

11. A medical waste disposal system according to claim 10 further comprising a bag restraining tray receivable with said tray hoop.

12. A medical waste disposal system according to claim 10 further comprising casters on said base.

13. A medical waste disposal system according to claim 1 further comprising a tray for surgical tools.

14. A medical waste disposal system according to claim 1 further comprising a fixture for holding a flexible bag in said first portion.

15. A medical waste disposal system according claim 1 comprising handle.

16. A medical waste disposal system according to claim 1 including separate storage containers for nonhazardous, non-waste material.

17. A medical waste disposal system according to claim 1 wherein said first portion comprises a drawer that slides in a reciprocal manner in and out of said upright body.

18. A medical waste disposal system according to claim 1 where said second portion comprises a drawer that slides in a reciprocal manner in and out of said upright body.

19. A medical waste disposal system according to claim 1 wherein said upright body includes an upright hinge for opening the body in a clamshell manner to obtain access to the waste bags and sharp containers.

20. A medical waste disposal system according to claim 1 comprising a foot pedal system for opening a lid on said system.
